(19) United States
(12) Patent Application Publication
(10) Pub. No.: US 2016/0042307 A1
(43) Pub. Date: Feb. 11, 2016

(54) SYSTEM TO PROVIDE SMART IMPECCABLE SERVICE AND ACCOUNTABILITY.

(71) Applicant: Yvette Valle, Yonkers, NY (US)

(72) Inventor: Yvette Valle, Yonkers, NY (US)

(21) Appl. No.: 14/819,791

(22) Filed: Aug. 6, 2015

Related U.S. Application Data
(60) Provisional application No. 62/033,767, filed on Aug. 6, 2014.

(51) Int. Cl. G06Q 10/06

(52) U.S. Cl. CPC G06Q 10/06398

(57) ABSTRACT

Methods and systems for providing utmost customer service, accountability, and job performance are described. An example method may involve a computing device determining a particular client associated with a specific plan and as a result compiles a corresponding database, propagates configuration data towards at least one apparatus, which is thereby enabled to interact with an agent and exchange a plurality of data points with the computing device for use in updating the corresponding database. The plurality of data points are associated with resources expanded and the agent in performing one or more tasks assigned to the agent via the apparatus.

### CROSS REFERENCE TO RELATED APPLICATIONS

This application claims the benefit to U.S. Provisional Application No. 62/033,767, filed on Aug. 6, 2014, which application is incorporated herein by reference as if set forth in its entirety.

### FIELD OF THE INVENTION

The present invention relates generally to the field of network communications, and more particularly to system and method for providing smart, impeccable service and accountability.

### BACKGROUND OF THE INVENTION

In the hospitality industry, utmost customer care service is expected. Unaccountable employees lead to poor customer service, which in turn can result in loss of revenue. Currently, employee accountability in job performance is based on paper schedule, phone call and radio contact. This arrangement does not provide adequate accountability, job performance and transparency in the operation of an establishment in the industry. This invention relies on a method to provide utmost customer service, accountability, and job performance. The method provides a follow-up system within a webpage and associated application.

### SUMMARY OF THE INVENTION

Various embodiments provide a system and method for providing smart, impeccable service and accountability.

The efficient use of the system results in impeccable service, lower overall cost, inventory control and optimization.

In one embodiment, a system for providing smart, impeccable service and accountability is provided. The system comprises a at least one computing device communicatively coupled to at least one apparatus; a memory having stored thereon instructions that upon execution by the at least one computing device, cause the at least one computing device to compile one or more databases associated with a specific client, to propagate configuration data towards the at least one apparatus, thereby enabling said at least one apparatus to interact with an agent of the specific client and exchange a plurality of data points with the at least one computing device for use in updating the one or more corresponding databases, wherein the plurality of data points are associated with said agent in performing one or more tasks assigned to said agent via the at least one apparatus.

Another embodiment provides a method for providing smart, impeccable service and accountability. The method may involve a computing device receiving a plurality of data points corresponding to one or more supervisor users and at least one apparatus. The method may also involve the computing device determining one or more subset of data points indicative of the identity of said one or more supervisor users and said at least one apparatus. The method may further involve a function based on an output of a comparison of the one or more predefined identification data with the subset of data points, the computing device compiles one or more databases associated with a specific client, propagates toward the at least one apparatus configuration data thereby enabling said at least one apparatus to interact with an agent of the specific client and exchange a plurality of data points with the at least one computing device for use in updating the one or more corresponding databases, wherein the plurality of data points are associated with said agent in performing one or more tasks assigned to said agent via the at least one apparatus.

Yet another embodiment provides a non-transitory computer readable medium. The non-transitory computer readable medium has stored thereon instructions that, upon execution by a computing device, cause the computing device to perform certain functions. The functions may include receiving a plurality of data points corresponding to one or more supervisors and at least one apparatus. The functions may also include determining one or more subset of data points indicative of the identity of said one or more supervisors and said at least one apparatus. The functions may further include, based on an output of a comparison of the one or more predefined identification data with the subset of data points, the computing device compiles one or more databases associated with a specific client, propagates toward the at least one apparatus configuration data thereby enabling said at least one apparatus to interact with an agent and exchange a plurality of data points with the at least one computing device for use in compiling a corresponding database, wherein the plurality of data points are associated with resources expanded and said agent in performing one or more tasks assigned to said agent via the at least one apparatus.

### BRIEF DESCRIPTION OF THE DRAWINGS

The teachings of the present invention can be readily understood by considering the following detailed description in conjunction with the accompanying drawings, in which:

FIG. 1 depicts a high-level block diagram of a system benefiting from embodiments of the present invention;

FIG. 2 depicts a high-level block diagram of an implementation according to the system of FIG. 1;

FIG. 3 depicts an exemplary computing device suitable for use in the system depicted in FIG. 1; and

FIG. 4 depicts one embodiment of a method for providing smart, impeccable service and accountability.

To facilitate understanding, identical reference numerals have been used to designate elements having substantially the same or similar structure and/or substantially the same or similar function.

### DETAILED DESCRIPTION OF THE INVENTION

Various embodiments provide a system and method for providing smart impeccable service and accountability.

The illustrative system and method embodiments described herein are not meant to be limiting. It may be readily understood that certain aspects of the disclosed system and method can be arranged and combined in a variety of different configurations, all of which are contemplated herein.

An example computing device may be configured to receive a plurality of data points corresponding to one or more clients locally or remotely communicating with the computing device. For example, the plurality of data points may take the form of identification data individualizing a specific and particular client. From the plurality of data points, the computing device can then authenticate the client. The computing device may also be configured to determine the apparatus the client is using. Then, the computing device would propagate configuration data towards the client's apparatus.

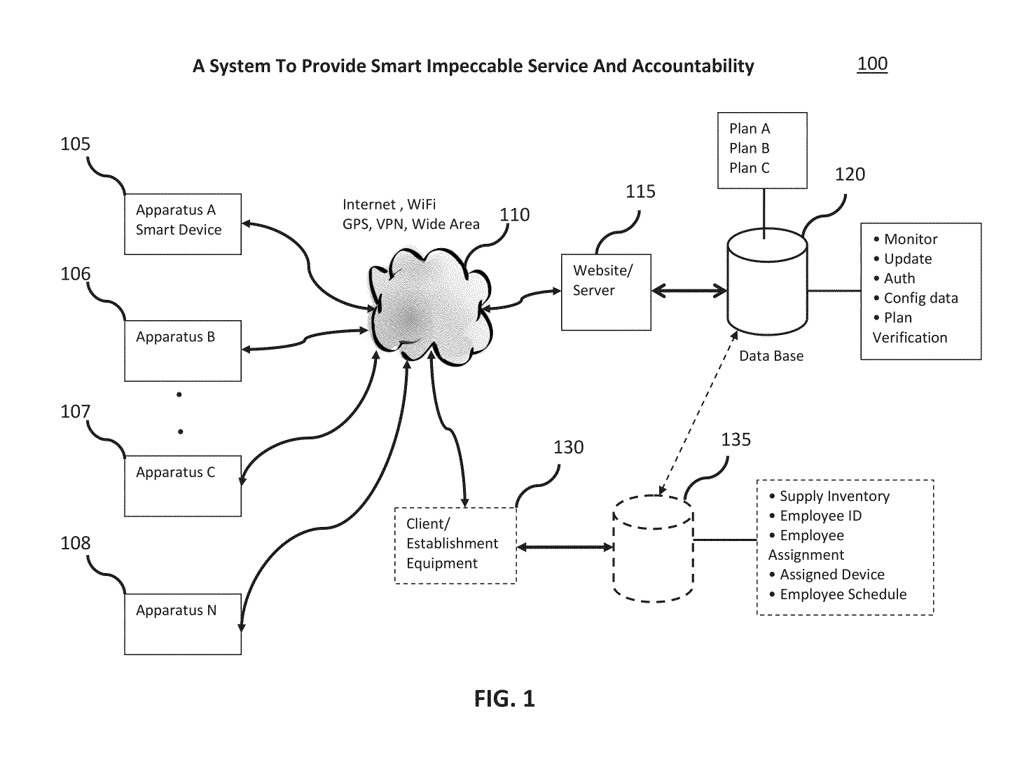

Referring now to the figures, FIG. 1 is a simplified block diagram of a system 100, according to an exemplary embodiment herein described. Components which may be included in the architecture of system 100 are one or more apparatus 105-108, communication means 110, website or server 115, data base 120. The architecture of system 100 may also include equipment 130, data base 135, software and operating systems (OS).

Generally speaking, apparatus 105-108 include any Internet enabled device such as personal digital assistant (PDA), laptop, desktop, electronic book, tablets and the like capable of accessing the Internet may implement the various embodiments described herein. While apparatus 105-108 are generally discussed within the context of the description, the use of any device having similar functionality is considered to be within the scope of the present embodiments.

In one embodiment, website or server 115 interacts with apparatus 105-108, client device 130 via link 110 depicted as a cloud. In one embodiment, link 110 extends over great distance and is a cable, satellite or fiber optic link, a combination of such links or any other suitable communications path. In other embodiments, link 110 extends over a short distance. In other embodiments, link 110 may be a local area network, or may be network connections between geographically distributed systems, including network connection over the Internet. In other embodiments, link 110 is wireless. In some embodiments, link 110 comprises Satellite communication, which is generally a geo-synchronous satellite system such as global positioning system (GPS). In one embodiment, satellite 110 is low earth orbit satellite system. In other embodiments, the use of any system having similar functionality is considered to be within the scope of the present embodiments. In some embodiments, link 110 comprise a Cellular system, which is generally a wireless infrastructure supporting cellular network functionality. In one embodiment, cellular system 110 is a small area wireless system. In other embodiments, cellular system 110 is a wide area wireless system. In other embodiments, cellular system 110 is a Wi-Fi system. In other embodiments, the use of any wireless system having similar functionality is considered to be within the scope of the present embodiments. The infrastructure is architected to provide the appropriate and necessary wireless/communication services offered by the network service provider. The network service provider manages the network to provide its service offerings to its wireless/mobile users in a manner consistent with the consumer expectations. For example, wireless/mobile users (e.g., users of smart phones, computers and the like purchasing various service offerings) very near perfect data services, glitch-free streaming media and the like.

Link 110 may be an access network. In one embodiment, network 110 is a virtual private network (VPN). In other embodiments, any network having similar functionality is considered to be within the scope of the present embodiments.

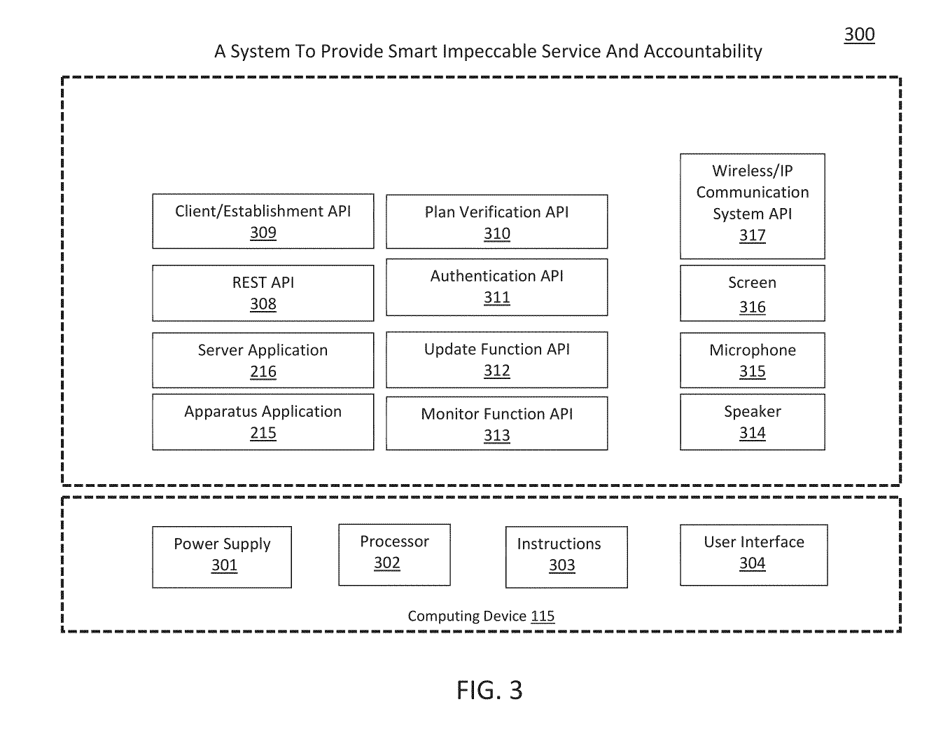

Generally speaking, website or server 115 includes any computing device depicted in FIG. 3. While computing device 115 is generally discussed within the context of the description, the use of any computing device having similar functionality is considered to be within the scope of the present embodiments.

In some embodiments, computing device 115 may be configured to determine a specific plan associated with a particular client. Computing device 115 may also be configured to perform the functions such as authenticating users and clients at login, monitoring, updating clients' account and providing configuration data to apparatus 105-108, which may be configured to communicate and exchange data with computing device 115 via communication means 110. Communication information comprises information useful in ascertaining or inferring the connections between computing device 115 and/or apparatus 105-108 and so on. That is, communication information is information provided by computing device 115 from the subjective perspective of the computing device. Communication information illustratively includes, but is not limited to, notification messages, destination device and the like.

Operating information comprises status/operating information associated with the operating state of a specific device and/or the sub-elements associated with that device. Status/operating information illustratively includes, but is not limited to, information providing operating status/alarm indicators, including information pertaining to metrics such as utilization level, apparatus pass/fail indication, unresponsive apparatus and the like.

(Data Base) DB 120 stores data which may be generated by and used by one or more of the programs of computing device 115 memory. In one embodiment, DB 120, 135 may be implemented as a single database. In some embodiments, multiple databases are implemented in any of the arrangements known to those skilled in the art.

Components of system 100 may be configured to operate in an interconnected manner with each other and/or with other components coupled to respective systems. For example, equipment 130 may be added to the architecture in a scalable fashion. In one embodiment, system 100 may initially leave out equipment 130. The functions of equipment 130 would then be performed within computing device 115, including but not limited to implementing data base 135. DB 135 include but is not limited to storing information about a client's supply inventory, employee ID, employee assignment, assigned apparatus or device ID, employee schedule and the like. In some embodiments, the functions of equipment 130 are migrated and implemented in equipment 130.

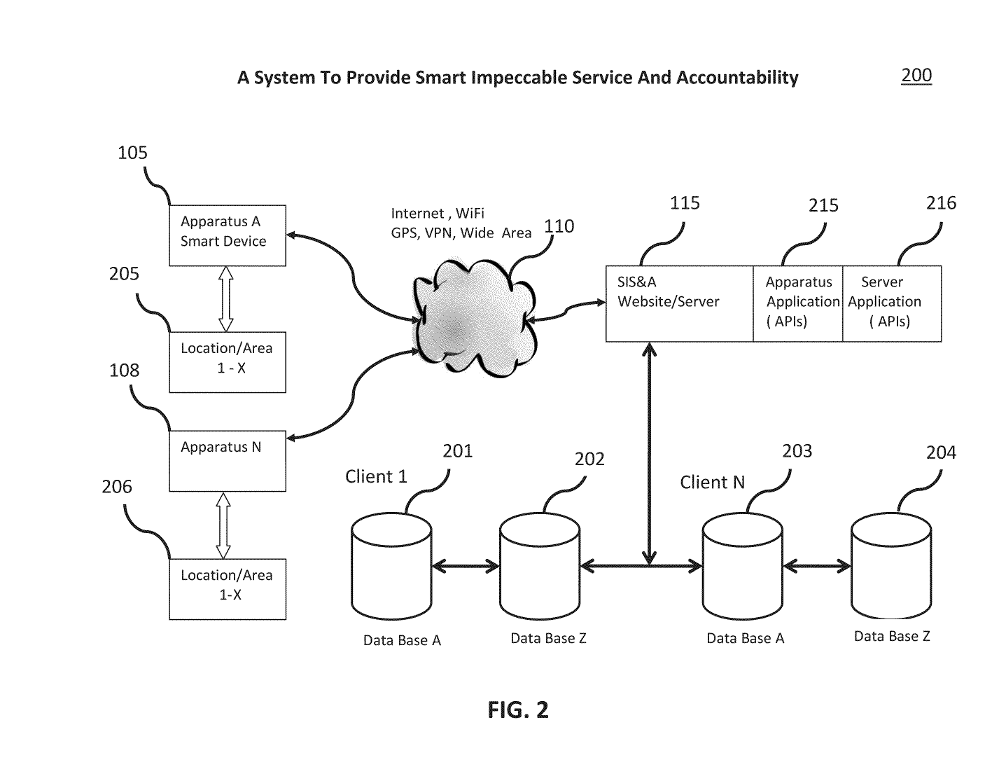

FIG. 2 depicts a high-level block diagram of an implementation according to the system of FIG. 1.

Although primarily depicted and described with respect to apparatus 105, 108, client 1 associated with (Data Base) DB A (201), DB Z (202) and client N associated with DB A (203), DB Z (204), it will be appreciated that the architecture may be divided in any other suitable division for providing the services associated with system 100.

In one embodiment, system 100 includes one (1) apparatus 105 and one (1) client. In one embodiment, the client is a hotel. Apparatus 105 may be a smart device, which is configured to provide a worker or agent associated with the specific apparatus with a list of all check-outs and check-ins of the prior day to set-up the cleaning for each room based on arrival times in conjunction with check-outs. In some embodiment, configuration data propagated towards apparatus 105 comprises a link, a compounded link and the like. In other embodiments, configuration data propagated towards apparatus 105 comprises discrete data or series of data points orchestrated in a synchronous manner. In yet other embodiments, the configuration data expires after a set time or cascaded expiration time.

In another embodiment, system 100 includes a plurality of apparatus 105 associated with one (1) client. In yet another embodiment, system 100 includes a plurality of apparatus 105-108 associated and with a plurality of clients. Although primarily depicted and described with respect to the aforementioned embodiments, it will be appreciated that the architecture may be designed in any other suitable arrangement for providing the services associated with system 100.

FIG. 3 depicts an exemplary computing device suitable for use in the system depicted in FIG. 1. Computing device 115 may include power supplies 301, a processor 302, a memory 303 for storing instructions and the like, a user interface 304. Power supply 301 provides power to computing device 115. As such, the power supply may include, for example backup batteries. Other power supply configurations are possible as well. Processor 302 included in computing device 115 may comprise one or more general-purpose processors and/or one or more special-purpose processors (e.g., image processor, digital signal processor, vector processor, etc.). To the extent that computing device 115 includes more than one processor, such processors could work separately or in combination. Computing device 115 may be configured to control functions of system 100 based on input received from one or more clients via user interface 304, for example.

Memory 303 may comprise one or more volatile and/or nonvolatile storage components such as optical, magnetic, and/or organic storage and memory 303 may be integrated in whole or in part with computing device 115. Memory 303 may contain instructions (e.g., applications programming interface, configuration data) executed by processor 302 in performing various functions of system 100, including any of the functions or methods described herein. Memory 303 may further include instructions executable by processor 302 to control and/or communicate with the additional components.

Peripherals may include speaker 314, microphone 315, and screen 316. Speaker 314 may be configured to output audio to the user of system 100. Similarly microphone 315 may be configured to receive audio from a user of system 100. Screen 316 may comprise one or more devices used for displaying information to the user of computing device 115. Screen 316 may comprise a touchscreen used by a user to input commands to computing device 115. As such, a touchscreen may be configured to sense at least one of a position in the movement of a user's finger via capacitive sensing, or a surface acoustic wave process among other possibilities. Generally, a touchscreen may be capable of sensing finger movement in a direction parallel or perpendicular to the touchscreen surface of both, and may also be capable of sensing a level of pressure applied to the touchscreen surface. A touchscreen comes in different shapes and forms.

Computing device 115 may include one or more elements in addition to or instead of those shown.

System 100 is developed mainly on two platforms namely, Apparatus application 215 and Server application 216. Apparatus application 215 is developed using JAVA and Eclipse as SDK (Software Development Kit). Server application 216 is developed using PHP language and MySQL as data base. Languages equivalent to JAVA and Eclipse, PHP and MySQL may be used to build Apparatus application 215 and Server application 216. Various APIs (308, 309, 310, 311, 312, 313) are used for the various functions (described in greater details infra) of system 100. For example, (Representational State Transfer) REST API 308, Wireless/IP Communication System API 317 (HTTP) are mainly used for web services. REST APIs are also used to connect database on the server with Apparatus application 215.

These APIs are also used in various embodiments for transferring data from Server application 216 to Apparatus application 215. Although depicted and described with respect to the aforementioned APIs, it will be appreciated by those skilled in the art that other APIs having similar functionality are considered to be within the scope of the present embodiments.

In one embodiment, APIs (308, 309, 310, 311, 312, 313) are used for passing Email and password parameters from Apparatus application 215 to Server application 216 and used to validate the login of the agent or worker.

In one embodiment, APIs (308, 309, 310, 311, 312, 313) transfer Email parameters from Apparatus application 215 to Server application 216 and new password is sent to the agent's or worker's email.

In one embodiment, APIs (308, 309, 310, 311, 312, 313) pass Agent or worker's ID (identification), supervisor ID, date, time parameters from Apparatus application 215 to Server application 216 to get the list of task on that particular date assigned to a particular agent or worker.

In one embodiment, Start time, QR code, room number parameters or location identifier are passed by APIs (308, 309, 310, 311, 312, 313) from Apparatus application 215 to Server application 216.

In one embodiment, End time, Job ID parameters are passed by APIs (308, 309, 310, 311, 312, 313) from Apparatus application 215 to Server application 216 and images are uploaded using an API to pass “before” and “after” images or photographs to Server application 216.

Although depicted and described with respect to an embodiment in which each of the APIs, engines, databases, and tools is stored within memory 303, it will be appreciated by those skilled in the art that the APIs, engines, database, and/or tools may be stored in one or more other storage devices internal to computing device 115 and/or external to computing device 115. The APIs, engines, databases, and/or tools may be distributed across any suitable numbers and/or types of storage devices internal and/or external to computing device 115.

The APIs, engines and tools may be activated in any suitable manner. In one embodiment, for example, the APIs, engines and tools may be activated in response to manual requests initiated by a user, in response to automated requests initiated by computing device 115, or other devices and the like, as well as various combinations thereof.

For example, where an engine or tool is activated automatically, the engine or tool may be activated in response to scheduled requests, in response to requests initiated by computing device 115 based on processing performed at computing device 115 or apparatus 105-108.

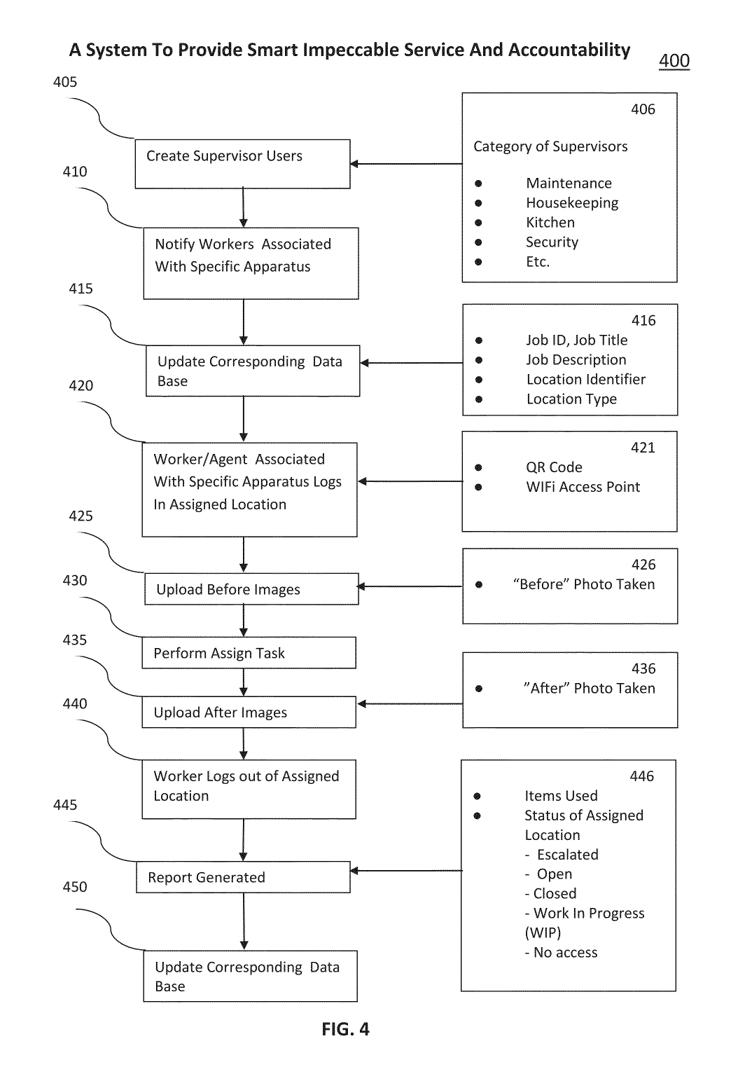

FIG. 4 depicts one embodiment of a method for providing smart, impeccable service and accountability. Specifically, FIG. 4 depicts a flow diagram of a method 400 adapted for use in implementing the application of system 100.

Various embodiments operate to provide a flexible tool that can be tuned to achieve some of the above outlined objectives without sacrificing others. For example, in one embodiment a guest books or reserves a room. Subsequently the guest sends an email confirming the booking or reservation. The client/establishment sends an email to the guest with a check list to inquire about any special needs and obtains possible arrival time. The appropriate department is informed of any special needs and arrival time. As such, necessary arrangements are made to accommodate the guest. In one embodiment, the housekeeping department of an establishment receives on apparatus 105-108 a list of all check-outs and check-ins prior day. Housekeeping will be given an arrival time so room or location 205-206 can be prepped. If issues arise, they can be dealt with. Each room location 205-206 will have a vacant time, which will be triggered when room or location 205-206 is checked out.

At step 405, the client's administration, staff or designated party creates supervisor users, who can log into server 115 to create workers and assign tasks to the workers. Referring to box 406, the category of supervisors includes maintenance, housekeeping, kitchen, security and the like. Although depicted and described with respect to the category of supervisors herein listed, it will be appreciated by those skilled in the art that the category is specific to an industry. The category of supervisors may be chosen across specific industries in any suitable category.

At step 410, a worker or agent associated with an apparatus 105-108 is notified on the apparatus with details of a task. In one embodiment, the apparatus is a smart device. In some embodiment, the details of the task include room number or location identifier, task description. In one embodiment, room 205-206 contains the details of the rooms of an establishment such as a hotel. The details of room 205-206 include the room's ID, room number, the room type (Presidential, Queen, King), the status of room 205-206 (occupied or vacant) and hotel ID.

At step 415, subsequent to notification being sent to the worker or agent, the corresponding data base is updated. Referring to box 416, in one embodiment the data base is populated with the job identification, the job title, the job description, the room number 205-206 or location identifier and room type.

At step 420, the worker or agent associated with a specific apparatus 105-108 acknowledges the notification by signing into the assigned location or room 205-206. Referring to box 421, in one embodiment the worker scans the bar code (QR Code) using apparatus 105-108 associated with the worker or agent. As such, a timestamp is created recording the time the worker entered the room or location 205-206. The bar code is placed in an inconspicuous area of the room or location 205-206. In another embodiment, the worker logs into a Wi-Fi Access point using the apparatus associated with the worker or agent. Again, a timestamp is created recording the time the worker or agent entered the room or location 205-206. The Wi-Fi Access point is also placed in an inconspicuous area of the room or location 205-206.

At step 425, the worker or agent uploads the “before” images or photos of the room or location. Referring to box 426, in one embodiment subsequently (after signing into the room or location 205-206) the worker or agent takes a photo of the room or location before performing the assigned task, for example cleaning room 205-206. Thus, the state of room 205-206 before the task is performed is recorded and saved. In another embodiment, the apparatus associated with the worker or agent proceeds to take the photo upon sign-in. The apparatus then instructs the worker or agent to aim at the different areas of room 205-206 to be photographed.

At step 430, the worker or agent performs the assigned task. In one embodiment, a check list is presented to the worker or agent to check off all items used in performing the task. As such, inventory may be controlled and optimized.

At step 435, the worker or agent uploads the “after” images or photos of room or location 205-206. Referring to box 436, in one embodiment after completing the task, the worker or agent takes a photo of room or location 205-206 after performing the assigned task, for example cleaning room 205-206. Thus, the state or condition of room 205-206 after the task is performed is recorded and saved. In another embodiment, photos of damaged areas are taken.

At step 440, the worker or agent associated with a specific apparatus 105-108 signs out of the assigned location or room 205-206. As such, a timestamp is created recording the time the worker entered room or location 205-206. The bar code is placed in an inconspicuous area of room or location 205-206. In another embodiment, the worker logs into a Wi-Fi Access point using the apparatus associated with the worker or agent. Again, a timestamp is created recording the time the worker or agent entered room or location 205-206. The Wi-Fi Access point is also placed in an inconspicuous area of room or location 205-206.

At step 445, a report is generated. Referring to box 446, the report outlines the items used, the status of the assigned room or location 205-206. The status indicates if the room or location is closed, open, work is in progress (WIP) or no access. In one embodiment, the status would indicate that an issue exists requiring that room 205-206 be escalated. For example, if a maintenance issue exists the worker or agent would so note in the comment area provided in the apparatus. A photo would be taken and forwarded to the appropriate party. The status of the room would indicate that this room has been escalated due to repairs. In such case, a request for a work order for repairs will go through maintenance. The corresponding data base would be updated. Front desk will be aware of the status of room or location 205-206 and act accordingly. In one embodiment, room or location 205-206 is pushed back for a later check-in. In another embodiment, the status will be escalated until maintenance scans into the room and complete the needed repairs, takes photos, lists the materials used and change the status to complete and signs out of room 205-206. An updated report would be generated and all parties concerned would be so alerted. Although depicted and described with respect to a particular report, it will be appreciated by those skilled in the art that the report could be tailored for any suitable objective.

At step 450, corresponding data bases are updated. Although primarily depicted and described herein with respect to the “room or location” embodiments, it will be appreciated that the algorithm may be used in other embodiments.

Although various embodiments which incorporate the teachings of the present invention have been shown and described in detail herein, those skilled in the art can readily devise many other varied embodiments that still incorporate these teachings.

We claim:

1. A system comprising:
at least one computing device communicatively coupled to at least one apparatus;
a memory having stored thereon instructions that upon execution by the at least one computing device, cause the at least one computing device to compile one or more databases associated with a specific client, to propagate configuration data towards the at least one apparatus, thereby enabling said at least one apparatus to interact with an agent of the specific client and exchange a plurality of data points with the at least one computing device for use in updating the one or more corresponding databases,
wherein the plurality of data points are associated with said agent in performing one or more tasks assigned to said agent via the at least one apparatus.

2. The system of claim 1, wherein the at least one computing device includes a web site, a web server.

3. The system of claim 1, wherein the at least one apparatus includes a smart device.

4. The system of claim 3, wherein the at least one apparatus further includes a desk top computer, a super-computer, a laptop.

5. The system of claim 3, wherein the at least one apparatus further includes a local area network (LAN), a virtual private network (VPN), a wide area network (WAN).

6. The system of claim 1, wherein the agent is a robot, a smart device, an API (Application Programming Interface), a worker.

7. The system of claim 1, wherein the agent signs in one location and signs out from said location via one or more data points located in an inconspicuous place within the location.

8. The system of claim 7, wherein the one or more data points include a QR code, a WiFi Access Point.

9. The system of claim 7, wherein the agent proceeds to another location when a specific condition is met.

10. The system of claim 9, wherein the specific condition includes completed assignment, end of a shift period, redirection.

11. The system of claim 1, wherein the one or more corresponding data bases are compiled and updated by the specific client device, said client being associated with a specific plan and said databases being updated synchronously.

12. The system of claim 11, wherein said databases are updated randomly, on a scheduled basis, in real time or on demand.

13. The system of claim 1, wherein said data bases are updated synchronously, randomly, on a scheduled basis, in real time or on demand.

14. A method comprising:
a computing device receiving a plurality of data points corresponding to one or more supervisor users and at least one apparatus;
the computing device determining one or more subset of data points indicative of the identity of said one or more supervisor users and said at least one apparatus;
based on an output of a comparison of the one or more predefined identification data with the subset of data points, the computing device compiles one or more databases associated with a specific client, propagates toward the at least one apparatus configuration data thereby enabling said at least one apparatus to interact with an agent of the specific client and exchange a plurality of data points with the at least one computing device for use in updating the one or more corresponding databases,
wherein the plurality of data points are associated with said agent in performing one or more tasks assigned to said agent via the at least one apparatus.

15. The method of claim 14, wherein said one or more supervisor users include a supervisor from each department or category.

16. The method of claim 15, wherein said one or more supervisors create one or more agents and assign one or more corresponding tasks to said one or more agents.

17. A non-transitory computer readable medium having stored thereon instructions that, upon execution by a computing device, cause the computing device to perform functions comprising:
receiving a plurality of data points corresponding to one or more supervisors and at least one apparatus;
the computing device determining one or more subset of data points indicative of the identity of said one or more supervisors and said at least one apparatus;
based on an output of a comparison of the one or more predefined identification data with the subset of data points, the computing device directs toward the at least one apparatus configuration data thereby enabling said at least one apparatus to interact with an agent and exchange a plurality of data points with the at least one computing device for use in compiling a corresponding database,
wherein the plurality of data points are associated with resources expanded and said agent in performing one or more tasks assigned to said agent via the at least one apparatus.

18. The non-transitory computer readable medium of claim 17, wherein the computing device is a first computing device, the functions further comprising uploading before and after images of a location.

19. The non-transitory computer readable medium of claim 17, wherein the computing device is a second computing device, a network, a virtual private network (VPN), a wide area network (WAN).

20. A non-transitory computer readable medium having stored thereon instructions that, upon execution by a computing device, cause the computing device to perform functions comprising:
compiling one or more databases associated with a specific client, propagating configuration data towards the at least one apparatus, thereby enabling said at least one apparatus to interact with an agent of a specific client and exchange a plurality of data points with the at least one computing device for use in updating the one or more corresponding databases,
wherein the plurality of data points are associated with said agent in performing one or more tasks assigned to said agent via the at least one apparatus.
